(19) United States
(12) Patent Application Publication
(10) Pub. No.: US 2024/0170204 A1
(43) Pub. Date: May 23, 2024

(54) MAGNETIC DEVICE AND LLC SERIES RESONANT CONVERTER HAVING THE SAME

(71) Applicant: LITE-ON TECHNOLOGY CORPORATION, Taipei (TW)

(72) Inventors: Chen CHEN, Taipei (TW); De-Jia LU, Taipei (TW); Kai-De CHEN, Taipei (TW); Yong-Long SYU, Taipei (TW); Chao-Lin CHUNG, Taipei (TW)

(21) Appl. No.: 18/224,078

(22) Filed: Jul. 20, 2023

(30) Foreign Application Priority Data
Nov. 23, 2022 (TW) 111144816

(51) Int. Cl. H01F 27/38; H02M 1/00; H02M 3/335

(52) U.S. Cl. CPC H01F 27/38; H02M 1/0058; H02M 1/0064; H02M 3/33507; H02M 3/33592; H01F 2027/2819

(57) ABSTRACT

A magnetic device includes a base plate, a cover plate, a first winding column, a second winding column, a primary winding, a secondary winding and a supporting column. The base plate, having a first concave portion, is opposite to the cover plate. The first winding column and the second winding column are disposed between the bottom plate and the cover plate, respectively. The primary winding and the secondary winding are wound around the first winding column and the second winding column. The supporting column is disposed between the base plate and the cover plate. A first concave portion concaves from a first side of the base plate towards the first winding column and the second winding column along multiple directions. The primary winding and the secondary winding are wound and stacking along an extension direction of the first winding column and the second winding column.

This application claims the benefit of Taiwan application Serial No. 111144816, filed Nov. 23, 2022, the subject matter of which is incorporated herein by reference.

### BACKGROUND OF THE INVENTION

### Field of the Invention

The invention relates in general to a magnetic device and a power converter having the same, and more particularly to a horizontally distributed electromagnetic device and an LLC series resonant converter having the same.

### Description of the Related Art

Most isolated type DC-DC converters used in products, such as charger, server power supply, vehicle power supply and charging pile, adopt LLC series resonant converter. In comparison to other isolated type DC-DC converters, the LLC series resonant converter has the property of flexible switching in a full load range, and therefore can effectively reduce the switching loss under high-frequency switching.

A typical LLC series resonant converter includes a magnetic device with primary side coils and secondary side coils wound thereon. The magnetic device occupies major space of the LLC series resonant converter. Therefore, it has become a prominent task for the industries to provide a magnetic device having a reduced size and excellent energy conversion efficiency, and an LLC series resonant converter having the same.

### SUMMARY OF THE INVENTION

According to one embodiment of the present invention, a magnetic device is provided, wherein the magnetic device includes a base plate, a cover plate, a first winding column, a second winding column, a primary winding, a secondary winding and a supporting column. The base plate has a first concave portion and is opposite to the cover plate. The first winding column is disposed between the base plate and the cover plate and includes a first air gap. The second winding column is disposed between the base plate and the cover plate and includes a second air gap. The primary winding is wound around the first winding column and the second winding column. The secondary winding is wound around the first winding column and the second winding column. The supporting column is disposed between the base plate and the cover plate. The first concave portion concaves from a first side of the base plate towards the first winding column and the second winding column along multiple directions. The primary winding and the secondary winding are wound and stacking along an extension direction of the first winding column and the second winding column.

According to the above embodiment of the present disclosure, the LLC series resonant converter is optimized through a horizontal distributed type air gap structure, so as to make the magnetic device including: a base plate (or cover plate) having magnetic conductivity, a first winding column and a second winding column having air gap; a first primary side sub-winding (first primary sub-winding), a first secondary side positive half cycle sub-winding (first secondary sub-winding) and a first secondary side negative half cycle sub-winding (second secondary sub-winding) wound around the first winding column; a second primary side sub-winding (second primary sub-winding), a second secondary side positive half cycle sub-winding (third secondary sub-winding) and a second secondary side negative half cycle sub-winding (fourth secondary sub-winding) wound around the second winding column; and to combine them forming two center-tap rectifier circuits on the adjacent first and second winding columns.

With a concave portion formed on a side of the base plate (or cover plate) towards the first winding column and/or the second winding column along multiple directions, the volume and weight of the base plate can be reduced. Although such design may slightly increase iron loss (core loss) to the magnetic device, but it can lead a great reduce in the copper loss of the magnetic device. After the two kinds of loss are offset, the said design can still reduce the size, volume and weight of the horizontal magnetic device without affecting the overall efficiency of the LLC series resonant converter, hence achieving the miniaturization of the LLC series resonant converter and reducing the manufacturing cost of the LLC series resonant converter.

Besides, through a specific wiring arrangement, one set of rectifier switches concurrently conducted in a positive half cycle of the input current is arranged on the same side of two adjacent winding columns away from the base plate, and another set of rectifier switches concurrently conducted in a negative half cycle of the input current is arranged on the same side of two adjacent winding columns close to the base plate. Through such arrangement, the resistance difference between the rectifier switches conducted in the same direction can be reduced, so that current equalization effect can be generated, the current loss of the rectifier circuit can be effectively reduced, and the operating efficiency of the LLC series resonant converter can be increased.

### BRIEF DESCRIPTION OF THE DRAWINGS

The above and other aspects of the invention will become better understood with regard to the following detailed description of the preferred but non-limiting embodiment (s). The following description is made with reference to the accompanying drawings.

FIG. 1A is an equivalent circuit diagram of an LLC series resonant converter according to an embodiment of the present disclosure;

FIG. 1B is a top view illustrating the magnetic device of the LLC series resonant converter as depicted in FIG. 1A according to an embodiment of the present disclosure;

FIG. 1C is a cross-sectional view of the magnetic device taking along the cutting line C1 as depicted in FIG. 1B;

FIG. 1D is a perspective view of the magnetic device as depicted in FIG. 1B;

FIG. 2 is a top view of a magnetic device according to another embodiment of the present disclosure;

FIG. 3A is a top view of a magnetic device according to an alternate embodiment of the present disclosure; and

FIG. 3B is a perspective view of the magnetic device as depicted in FIG. 3A.

### DETAILED DESCRIPTION OF THE INVENTION

An LLC series resonant converter is provided in the embodiments of the present disclosure. Without affecting the overall efficiency of the LLC series resonant converter, the size, volume, weight, and manufacturing cost of the LLC series resonant converter can be reduced. The contents of the invention are disclosed in exemplary embodiments below with reference to the structure and arrangement described in the present specification.

It should be noted that exemplary embodiments of the present disclosure are for explaining and describing the contents of the present disclosure, not for accurately and comprehensively disclosing or limiting the contents of the invention. Besides, the embodiments of the present disclosure can be implemented using features, elements, procedures or parameters not specified in the present specification. Therefore, the descriptions and accompanying drawings of the present specification are for exemplification purpose only, not for limiting the scope of protection of present invention. Anyone skilled in the technology field of the invention will be able to make suitable modifications or changes based on the specification disclosed below without breaching the spirit of the invention. Moreover, the dimension scales used in the accompanying drawings are not based on actual proportions, and designations common to different embodiments are used to indicate identical or similar elements.

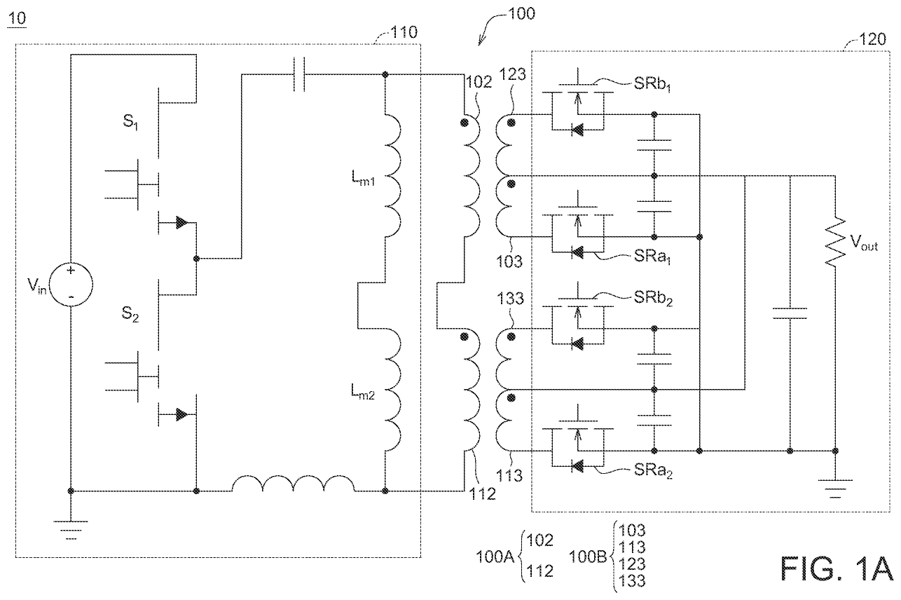

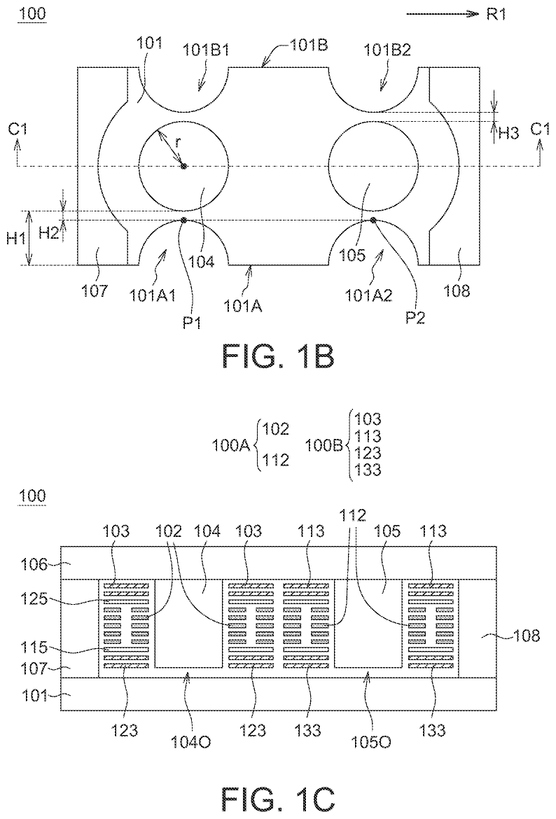

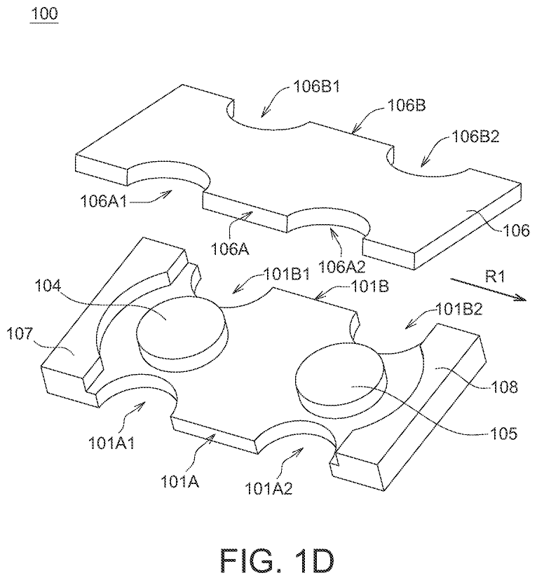

Referring to FIG. 1A, FIG. 1A is an equivalent circuit diagram of an LLC series resonant converter 10 according to an embodiment of the present disclosure. In the present embodiment, the LLC series resonant converter 10 includes a magnetic core element 100, a switch circuit 110 and a rectifier circuit 120.

The switch circuit 110 has an input voltage (input end) Vin, a first switch S1, a second switch S2 and magnetizing inductors Lm1 and Lm2. The first switch S1 and the second switch S2 are connected in series and are electrically connected to the input end Vin as well as a first primary side sub-winding 102 and a second primary side sub-winding 112.

The magnetic device 100 at least includes a primary winding 100A formed of a first primary side sub-winding (first primary sub-winding) 102 and a second primary side sub-winding (second primary sub-winding) 112 and a secondary winding 100B formed of a first secondary side positive half cycle sub-winding (first secondary sub-winding) 103, a second secondary side positive half cycle sub-winding (third secondary sub-winding) 113, a first secondary side negative half cycle sub-winding (second secondary sub-winding) 123 and a second secondary side negative half cycle sub-winding (fourth secondary sub-winding) 133. The first primary side sub-winding 102 and the second primary side sub-winding 112 are connected in series and are electrically connected to the switch circuit 110. The first secondary side positive half cycle sub-winding 103 and the second secondary side positive half cycle sub-winding 113 of the magnetic device 100 are connected in parallel and are electrically connected to the rectifier circuit 120. The first secondary side positive half cycle sub-winding 103 and the first secondary side negative half cycle sub-winding 123 are connected in parallel in opposite directions. The second secondary side positive half cycle sub-winding 113 and the second secondary side negative half cycle sub-winding 133 are connected in parallel in opposite directions.

The rectifier circuit 120 includes rectifier switches SRa1, SRa2, SRb1 and SRb2 and an output end Vout. The rectifier switch SRa1 connects the first secondary side positive half cycle sub-winding 103 and the output end Vout. The rectifier switch SRb1 connects the first secondary side negative half cycle sub-winding 123 and the output end Vout and is connected in parallel with the rectifier switch SRa1 in opposite directions. The rectifier switch SRa2 connects the second secondary side positive half cycle sub-winding 113 and the output end Vout. The rectifier switch SRb2 connects the second secondary side negative half cycle sub-winding 133 and the output end Vout and is connected in parallel with the rectifier switch SRa2 in opposite directions. The rectifier circuit 120 and the magnetic device 100 form two center-tap rectifier circuits.

When the first switch S1 is turned on, the second switch S2 is turned off, so that the input current flows through the first primary side sub-winding 102 and the second primary side sub-winding 112. The rectifier switches SRa1 and SRa2 are turned on concurrently, so that the induction current concurrently flows through the first secondary side positive half cycle sub-winding 103 and the second secondary side positive half cycle sub-winding 113. Meanwhile, the conducting direction of the induction current flowing through the first secondary side positive half cycle sub-winding 103 and the second secondary side positive half cycle sub-winding 133 is opposite to the conducting direction of the input current flowing through the first primary side sub-winding 102 and the second primary side sub-winding 112.

When the second switch S2 is turned on the first switch S1 is turned off, so that the input current flows through the first primary side sub-winding 102 and the second primary side sub-winding 112. The rectifier switch SRb1 and SRb2 turned on concurrently, so that the induction current concurrently flows through the first secondary side negative half cycle sub-winding 123 and the second secondary side negative half cycle sub-winding 133. Meanwhile, the conducting direction of the induction current flowing through the first secondary side negative half cycle sub-winding 123 and the second secondary side negative half cycle sub-winding 133 is opposite to the conducting direction of the input current flowing through the first primary side sub-winding 102 and the second primary side sub-winding 112.

Refer to FIG. 1B to FIG. 1D. FIG. 1B is a top view illustrating the magnetic device 100 of the LLC series resonant converter 10 as depicted in FIG. 1A according to an embodiment of the present disclosure. FIG. 1C is a cross-sectional view of the magnetic device 100 tacking along the cutting line C1 as depicted in FIG. 1B. FIG. 1D is a perspective view of the magnetic device 100 as depicted in FIG. 1B. For the clarity of illustration, the cover plate 106, the first primary side sub-winding 102, the second primary side sub-winding 112, the first secondary side positive half cycle sub-winding 103, the second secondary side positive half cycle sub-winding 113, the first secondary side negative half cycle sub-winding 123 and the second secondary side negative half cycle sub-winding 133 are omitted in FIG. 1B. The first primary side sub-winding 102, the second primary side sub-winding 112, the first secondary side positive half cycle sub-winding 103, the second secondary side positive half cycle sub-winding 113, the first secondary side negative half cycle sub-winding 123 and the second secondary side negative half cycle sub-winding 133 are omitted in FIG. 1D.

As indicated in FIG. 1B to FIG. 1D, the magnetic device 100 further includes a top base plate 101 with magnetic conductivity, a first winding column 104, a second winding column 105, a top cover plate 106, a first supporting column 107 and a second supporting column 108. The first winding column 104 and the second winding column 105 are protruded on the base plate 101, and arranged along a direction parallel to an extension direction R1 of the first side 101A of the base plate 101. Moreover, the first winding column 104 and the second winding column 105 respectively have at least one air gap 1040 and at least one 1050 capable of dividing the first winding column 104 and the second winding column 105 into several (two) segments.

The first supporting column 107 and the second supporting column 108 are also protruded on the base plate 101, and both do not have an air gap. In the present embodiment, the first supporting column 107 and the second supporting column 108 are arranged along a direction parallel to the direction R1. The first winding column 104 is disposed between the first supporting column 107 and the second supporting column 108. The second winding column 105 is disposed between the first winding column 104 and the second supporting column 108.

The cover plate 106 is disposed above the base plate 101, the first winding column 102, the second winding column 103, the first supporting column 107 and the second supporting column 108 and contacts the first winding column 102, the second winding column 103, the first supporting column 107 and the second supporting column 108.

As indicated in FIG. 1C, the first primary side sub-winding 102, the first secondary side positive half cycle sub-winding 103 and the first secondary side negative half cycle sub-winding 123 all are wound around the first winding column 104. The second primary side sub-winding 112, the second secondary side positive half cycle sub-winding 113 and the second secondary side negative half cycle sub-winding 133 all are wound around the second winding column 105. The second secondary side positive half cycle sub-winding 113 and the first secondary side positive half cycle sub-winding 103 both are disposed on one side away from the base plate 101. The first secondary side positive half cycle sub-winding 123 and the second secondary side negative half cycle sub-winding 133 both are disposed on the side close to the base plate 101.

In some embodiments of the present disclosure, the first primary side sub-winding 102, the second primary side sub-winding 112, the first secondary side positive half cycle sub-winding 103, the second secondary side positive half cycle sub-winding 113, the first secondary side negative half cycle sub-winding 123 and the second secondary side negative half cycle sub-winding 133 can be formed of a printed circuit board structure, a Litz wire coil or a copper sheet structure respectively. In the present embodiment, the first primary side sub-winding 102, the second primary side sub-winding 112, the first secondary side positive half cycle sub-winding 103, the second secondary side positive half cycle sub-winding 113, the first secondary side negative half cycle sub-winding 123 and the second secondary side negative half cycle sub-winding 133 can be formed of a printed circuit board structure respectively.

The first secondary side negative half cycle sub-winding 123 and the second secondary side negative half cycle sub-winding 133 are formed of two patterned conductive layers stacking above the base plate 101. The first primary side sub-winding 102 and the second primary side sub-winding 112 are formed of five patterned conductive layers stacking above the first secondary side negative half cycle sub-winding 123 and the second secondary side negative half cycle sub-winding 133. The first secondary side positive half cycle sub-winding 103 and the second secondary side positive half cycle sub-winding 113 are formed of two patterned conductive layers stacking above the first primary side sub-winding 102 and the second primary side sub-winding 112. The first secondary side negative half cycle sub-winding 123 and the second secondary side negative half cycle sub-winding 133 are electrically isolated from the first primary side sub-winding 102 and the second primary side sub-winding 112 through a masking layer (insulation layer) 115. The first secondary side positive half cycle sub-winding 103 and the second secondary side positive half cycle sub-winding 113 are electrically isolated from the first primary side sub-winding 102 and the second primary side sub-winding 112 through an insulation layer 125 (as indicated in FIG. 1C).

In some embodiments of the present disclosure, the first side 101A of the base plate 101 has at least one concave portion (for instance, concave portions 101A1 and 101A2), which concaves towards the first winding column 104 or the second winding column 105 along multiple directions. In the present embodiment (as indicated in FIG. 1B), the first side 101A of the base plate 101 has two concave portions 101A1 and 101A2 respectively concaving from the first side 101A towards the first winding column 104 and the second winding column 105 along multiple directions.

Since the concaving distances in different directions are not the same, the concave portions 101A1 and 101A2 respectively have an arc edge. The two peripheral positions P1 and P2 on the arc edge, each of which have the farthest distance measured (along an extension direction R1 perpendicular to the first side 101A) away from the first side 101A, are respectively aligned with the first winding column 104 and the second winding column 105. In the present embodiment, the concave portions 101A1 and 101A2 have an identical size and an identical edge shape. In other embodiments, the concave portion 101A1 and 101A2 can have different sizes and different edge shapes.

A first distance H1 from the first winding column 104 to the first side 101A (along the extension direction R1 perpendicular to the first side 101A) is substantially greater than a second distance H2 from the first winding column 104 (along the extension direction R1 perpendicular to the first side 101A) to the peripheral position P1 of the concave portion 101A1 (or the distance from the peripheral position P2 of the second winding column 105 to concave portion 101A2). The second distance H2 is less than a radius r of the first winding column 104 (or a radius of the second winding column 105). The ratio of the first distance H1 to the second distance H2 substantially ranges from 1 to 20.

In some embodiments of the present disclosure, the base plate 101 further includes a third side 101B parallel to the direction R1 and opposite to the first side 101A. The third side 101B has at least one concave portion (for instance, concave portion 1011B1 and 1011B2), which concaves towards the first winding column 104 and/or the second winding column 105 along multiple directions.

In the present embodiment, as indicated in FIG. 1B, the third side 101B of the base plate 101 has two concave portions 101B1 and 101B2, respectively corresponding to the two concave portions 101A1 and 101A2 on the first side 101A. Two corresponding concave portions 101A1 and 1011B1 have identical concaving size; two corresponding concave portions 101A2 and 101 B2 have identical concaving size. That is, the second distance H2 from the first winding column 104 to the edge of the concave portion 101A1 (or the distance from the second winding column 105 to the edge of the concave portion 101A2) is substantially equivalent to the third distance H3 from the first winding column 104 to the edge of the concave portion 1011B1 (or the distance from the second winding column 105 to the edge of the concave portion 101B2).

Furthermore, the cover plate 106 has a second side 106A and a fourth side 106B disposed in parallel, and the extension directions of the second side 106A and the fourth side 106B are parallel to the extension direction R1 of the first side 101A. The second side 106A has at least one concave portion (for instance, the concave portions 106A1 and 106A2), which concaves towards the first winding column 104 and/or the second winding column 105 along multiple directions. The fourth side 106B has at least one concave portion (for instance, the concave portions 106B1 and 106B2), which concaves towards the first winding column 104 and/or the second winding column 105 along multiple directions (as indicated in FIG. 1D).

In the present embodiment, the base plate 101 and the cover plate 106 stack with each other, and the second side 106A (and the concave portions 106A1 and 106A2) of the cover plate 106 is aligned with the first side 101A (and concave portion 101A1 and 101A2) of the base plate 101. The fourth side 106B (and the concave portions 106B1 and 106B2) of the cover plate 106 is aligned with the third side 101B (and the concave portions 101B1 and 101B2) of the base plate 101. The concave portions 101A1 and 101A2, along a direction parallel to the extension direction L1 of the first winding column 104 (or the extension direction of the second winding column 105) at least partly overlaps the concave portions 106A1 and 101A2, respectively. The concave portions 1011B1 and 101 B2 at least partly overlaps the concave portions 106B1 and 1011B2 respectively along a direction parallel to the extension direction L1 of the first winding column 104 (or the extension direction of the second winding column 105).

Through applying the concave portions 101A1, 101A2, 101B1, 101 B2, 106A1, 106A2, 106B1 and 106B2 on the base plate 101 and the cover plate 106, the volume and weight of the base plate 101 and the cover plate 106 can be greatly reduced. A comparison between the LLC series resonant converter 10 and existing LLC series resonant converter based on actual measurements shows that: although the application of the concave portions 101A1, 101A2, 101B1, 101 B2, 106A1, 106A2, 106B1 and 106B2 may cause slightly increasing in the iron loss (core loss) of the LLC series resonant converter 10, but it can lead a great reduce in the copper loss of the LLC series resonant converter 10. After the two kinds of loss are offset, this approach can still reduce the size, volume and weight of the horizontal magnetic device without affecting the overall efficiency of the LLC series resonant converter, hence achieving the miniaturization of the LLC series resonant converter 10 and reducing the manufacturing cost of the LLC series resonant converter 10.

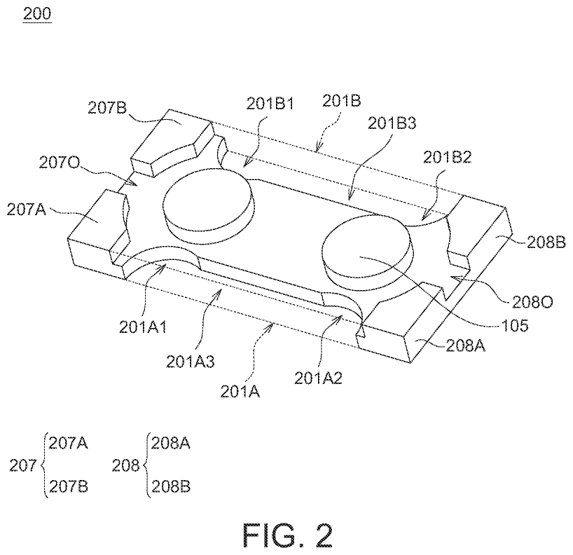

However, the arrangements of the base plate 101 and the cover plate 106 of the magnetic device 100 is not limited to the above exemplification. Referring to FIG. 2, a top view of a magnetic device 200 according to another embodiment of the present disclosure is shown. For the clarity of illustration, FIG. 2 omits the cover plate, the primary side winding and the secondary side winding.

The structure of the magnetic device 200 as depicted in FIG. 2 is similar to that of the magnetic device 100 as depicted in FIG. 1B except in that the magnetic device 200 further includes a concave portion 201A3, which concaves from the first side 201A of the base plate 201 and connects the concave portions 201A1 and 201A2, and a concave portion 2011B3, which concaves from the second side 201B of the base plate 201 and connects the concave portions 2011B1 and 201 B2.

For the purpose to make the primary side winding and the secondary side winding (not illustrated) to be easily wound, the first supporting column 207 of the magnetic device 200 further includes a gap 2070, which can divide the first supporting column 207 into two separate magnetic-conductive sub-supporting columns 207A and 207B. For the similar purpose, the second supporting column 208 further includes a gap 2080, which can divide the second supporting column 208 into two separate magnetic-conductive sub-supporting columns 208A and 208B.

In the present embodiment, the cover plate (not illustrated) of the magnetic device 200 can have a concave structure corresponding to the base plate 201. In other embodiments, in the magnetic device 200, the concave portion (not illustrated) of the cover plate and the concave portion 201A1, 201A2, 2011B1, 2011B2 of the base plate 201 can be independently arranged without correspondence.

Furthermore, in the magnetic device 300, the number and arrangements of the magnetic supporting columns are not limited to these regards, and anyone ordinarily skilled in the technology field of the present disclosure can make suitable modifications according to the primary side winding or the secondary side winding of the magnetic core element of the converter and the wiring requirements of the switch circuit and the rectifier circuit.

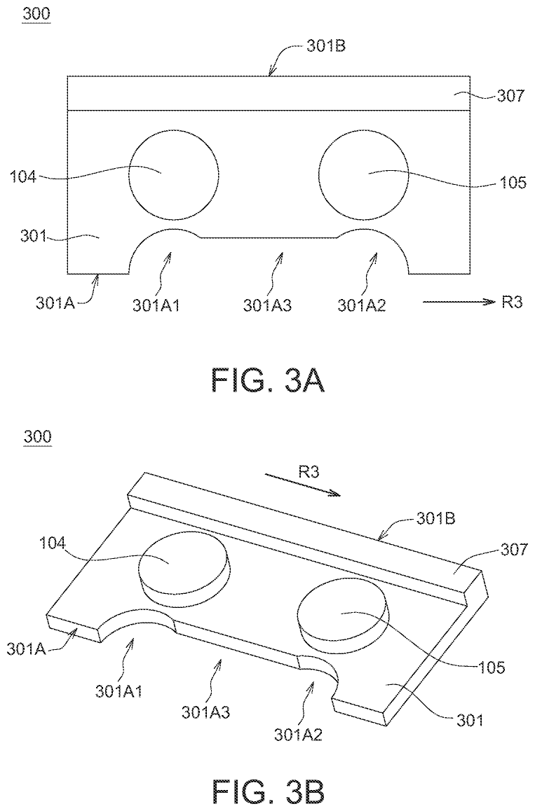

Refer to FIG. 3A and FIG. 3B. FIG. 3A is a top view of a magnetic device 300 according to an alternate embodiment of the present disclosure. FIG. 3B is a perspective view of the magnetic device 300 as depicted in FIG. 3A. For the clarity of illustration, FIG. 3A and FIG. 3B omit the cover plate, the primary side winding and the secondary side winding.

The structure of the magnetic device 300 as depicted in FIG. 3A is similar to that of the magnetic core element 100 as depicted in FIG. 1B, except in that: in the magnetic device 300, only one side (first side 301A) of the base plate 301 has concave portions 301A1, 301A2 and 301A3. The magnetic device 300 has only one supporting column 307, which is adjacent to the second side 301B of the base plate 301 and extends along an extension direction R3 perpendicular to the second side 301B.

Refer to FIG. 1A and FIG. 1C, since the first secondary side sub-winding 103 and the second secondary side sub-winding 113 are disposed on the same side farther away from the base plate 101, and the first auxiliary winding 123 and the second auxiliary winding 133 are disposed on the same side close to the base plate 101, thus through such wiring arrangement, the distances from the first secondary side sub-winding 103 and the second secondary side sub-winding 113 to the rectifier switches SRa1 and SRa2 are more consistent, and the distances from the first auxiliary winding 123 and the second auxiliary winding 133 to the rectifier switch SRb1 and SRb2 are more consistent; the resistance difference between the rectifier switches SRa1 and SRa2 (SRb1 and SRb2) of the rectifier circuit 120 that are turn on in the same direction can be reduced, so that current equalization effect can be generated, the current loss of the rectifier circuit 120 can be effectively reduced, and the current loss of the rectifier circuit can be effectively reduced, and the operating efficiency of the LLC series resonant converter 10 can be increased.

According to the above embodiments of the present disclosure, the LLC series resonant converter is optimized through a horizontal distributed type air gap structure, so as to make the magnetic device including: a base plate (or cover plate) having magnetic conductivity, a first winding column and a second winding column having air gap; a first primary side sub-winding, a first secondary side positive half cycle sub-winding and a first secondary side negative half cycle sub-winding wound around the first winding column; a second primary side sub-winding, a second secondary side positive half cycle sub-winding and a second secondary side negative half cycle sub-winding wound around the second winding column; and to combine them forming two center-tap rectifier circuits on the adjacent first and second winding columns.

With a concave portion formed on a side of the base plate (or the cover plate) towards the first winding column and/or the second winding column along multiple directions, the volume and weight of the base plate can be reduced. Although such design may slightly increase iron loss (core loss) to the magnetic device, but it can lead a great reduces in the copper loss of the magnetic device. After the two kinds of loss are offset, the said design can still reduce the size, volume and weight of the horizontal type of magnetic device without affecting the overall efficiency of the LLC series resonant converter, hence achieving the miniaturization of the LLC series resonant converter and reducing the manufacturing cost of the LLC series resonant converter.

Besides, through a specific wiring arrangement, one set of rectifier switches concurrently conducted in a positive half cycle of the input current is arranged on the same side of two adjacent winding columns away from the base plate, and another set of rectifier switches concurrently conducted in negative half cycle of the input current is arranged on the same side of two adjacent winding columns close to the base plate. Through such arrangement, the resistance difference between the rectifier switches conducted in the same direction can be reduced, so that current equalization effect can be generated, the current loss of the rectifier circuit can be effectively reduced, and the operating efficiency of the LLC series resonant converter can be increased.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A magnetic device, comprising:
a base plate, having a first concave portion;
a cover plate, opposite to the base plate;
a first winding column, disposed between the base plate and the cover plate and comprising a first air gap;
a second winding column, disposed between the base plate and the cover plate and comprising a second air gap;
a primary winding, wound around the first winding column and the second winding column;
a secondary winding, wound around the first winding column and the second winding column; and
a supporting column, disposed between the base plate and the cover plate;
wherein the first concave portion concaves from a first side of the base plate towards the first winding column and the second winding column along multiple directions, and the primary winding and the secondary winding stack along an extension direction of the first winding column and the second winding column.

2. The magnetic device according to claim 1, wherein the cover plate has a second concave portion, which concaves from a second side of the base plate towards the first winding column and the second winding column along multiple directions, and a projection of the second concave portion along the extension direction of the first winding column at least partly overlaps the first concave portion.

3. The magnetic device according to claim 1, wherein a first distance from the first winding column to the first side and perpendicular to the first side is substantially greater than a second distance from the first winding column to an edge of the first concave portion and perpendicular to the first side; and the second distance is less than a radius of the first winding column and/or the second winding column.

4. The magnetic device according to claim 3, wherein a ratio of the first distance to the second distance is greater than or equivalent to 1 and is less than or equivalent to 20.

5. The magnetic device according to claim 2, wherein the base plate further comprises a third side opposite to the first side; the cover plate has a fourth side opposite to the second side; the base plate has a third concave portion, which concaves from the third side of the base plate towards the first winding column and the second winding column along multiple directions; the cover plate has a fourth concave portion, which concaves from the fourth side of the base plate towards the first winding column and the second winding column along multiple directions.

6. The magnetic device according to claim 1, wherein the supporting column does not have air gap, and neither the primary winding nor the secondary winding is wound around the supporting column.

7. The magnetic device according to claim 1, wherein the primary winding has a first primary sub-winding and a second primary sub-winding; the secondary winding has a first secondary sub-winding, a second secondary sub-winding, a third secondary sub-winding and a fourth secondary sub-winding; the first primary sub-winding, the first secondary sub-winding and the second secondary sub-winding are wound around the first winding column; the first secondary sub-winding and the second secondary sub-winding are connected in parallel in opposite directions; the second primary sub-winding, the third secondary sub-winding and the fourth secondary sub-winding are wound around the second winding column; the third secondary sub-winding and the fourth secondary sub-winding are connected in parallel in opposite directions.

8. The magnetic device according to claim 7, wherein a number of coils of the first primary sub-winding is equivalent to a number of coils of the second primary sub-winding, and a direction of a current flowing through the first primary sub-winding is opposite to a direction of a current flowing through the second primary sub-winding.

9. The magnetic device according to claim 7, wherein a direction of a current flowing through the first primary sub-winding is opposite to a direction of a current flowing through the first secondary sub-winding and the second secondary sub-winding; and a direction of a current flowing through the second primary sub-winding is opposite to a direction of a current flowing through the third secondary sub-winding and the fourth secondary sub-winding.

10. The magnetic device according to claim 1, further comprises:
a masking layer disposed between the primary winding and the secondary winding.

11. An LLC series resonant converter, comprising:
a magnetic device, comprising:
a base plate, having a first concave portion;
a cover plate, opposite to the base plate;
a first winding column, disposed between the base plate and the cover plate and comprising a first air gap;
a second winding column, disposed between the base plate and the cover plate and comprising a second air gap;
a primary winding, wound around the first winding column and the second winding column;
a secondary winding, wound around the first winding column and the second winding column; and
a supporting column, disposed between the base plate and the cover plate;
wherein the first concave portion concaves from a first side of the base plate towards the first winding column and the second winding column along multiple directions, and the primary winding and the secondary winding stack along an extension direction of the first winding column and the second winding column;
wherein the primary winding has a first primary sub-winding and a second primary sub-winding; the secondary winding has a first secondary sub-winding, a second secondary sub-winding, a third secondary sub-winding and a fourth secondary sub-winding; the first primary sub-winding, the first secondary sub-winding and the second secondary sub-winding are wound around the first winding column; the first secondary sub-winding and the second secondary sub-winding are connected in parallel in opposite directions; the second primary sub-winding, the third secondary sub-winding and the fourth secondary sub-winding are wound around the second winding column; the third secondary sub-winding and the fourth secondary sub-winding are connected in parallel in opposite directions;
a first rectifier switch, connecting the first secondary sub-winding and an output end;
a second rectifier switch, connecting the third secondary sub-winding and the output end and connected in parallel with the first rectifier switch in opposite directions;
a third rectifier switch, connecting the second secondary sub-winding and the output end; and
a fourth rectifier switch, connecting the fourth secondary winding and the output end and connected in parallel with the third rectifier switch in opposite directions.

12. The LLC series resonant converter according to claim 11, further comprises:
a first switch, electrically connected to the first primary sub-winding, the second primary sub-winding and the input end; and
a second switch, connected in series with the first switch and electrically connected to the first primary sub-winding, the second primary sub-winding and the input end;
when the first switch is turned on, the first rectifier switch and the third rectifier switch are turned on; when the second switch is turned on, the second rectifier switch and the fourth rectifier switch are turned on.

13. The LLC series resonant converter according to claim 11, wherein the first primary sub-winding, the second primary sub-winding, the first secondary sub-winding, the second secondary sub-winding, the third secondary sub-winding and the fourth secondary sub-winding are respectively formed of a printed circuit board (PCB) structure, a Litz wire coil or a copper sheet structure.
